(19) United States
(12) Patent Application Publication
(10) Pub. No.: US 2016/0096124 A1
(43) Pub. Date: Apr. 7, 2016

(54) FLUID FILTRATION APPARATUSES AND FLUID FILTRATION SYSTEMS RELATED THERETO

(71) Applicant: H2O OILFIELD SERVICES, Houston, TX (US)

(72) Inventors: Timothy MARCO, Katy, TX (US); Larry HUPPERT, Fort Worth, TX (US); Robert ARIMOND, New Caney, TX (US)

(21) Appl. No.: 14/504,181

(22) Filed: Oct. 1, 2014

(51) Int. Cl. B01D 29/68; B01D 29/64

(52) U.S. Cl. CPC B01D 29/68; B01D 29/6469; B01D 29/6407

(57) ABSTRACT

A fluid filtration apparatus may have a fluid filtration platform and at least one self-cleaning filter component in fluid communication with the fluid filtration platform. The fluid filtration platform may have at least two segments where each segment may have at least one inlet, at least one outlet, and at least one valve. A first segment may be configured to be attachable to a second segment. A fluid filtration system may have or include at least one first tank comprising a recovered fluid, a fluid filtration apparatus in fluid communication with the first tank, and a second tank in fluid communication with the apparatus. Another fluid filtration system may have at least one charge pump, a fluid filtration apparatus in fluid communication with the charge pump(s), and at least one salt water disposal pump in fluid communication with the apparatus for pumping a fluid into salt water disposal wells.

### TECHNICAL FIELD

The present invention relates to a portable fluid filtration apparatus for filtering recovered fluids and fluid filtration systems incorporating the apparatus thereinto.

### BACKGROUND

When fluids are recovered from a hydrocarbon recovery operation, the additives, bacteria, hydrocarbon components, etc. must be removed from the fluid prior to recycling the filtered fluid for the same or different operation (i.e. whether the operation is hydrocarbon recovery, irrigation, municipality, well water, etc.), reusing the filtered fluid in the same or different hydrocarbon operation, and/or discharging the filtered fluid into the environment.

In an oil or gas well, water is used to cool and lubricate the drillbit and to extract debris. Accordingly, drilling a well may require hundreds of thousands of gallons of water. In addition, completion fluids (for completing wells), fracturing fluids (for fracturing a subterranean formation), and injection fluids (for recovering additional hydrocarbons via a secondary or tertiary recovery mechanism) may also require large amounts of water. Production fluids are fluids produced from a well that may also include water, along with hydrocarbon components. To accommodate the supply of water typically needed for such operations, water is usually transported through temporary pipelines or trucked to the site of the hydrocarbon recovery operation. Much of the water used during these operations may be recovered as flowback water, and the flowback water and/or production water must be managed as it is recovered from the well at the hydrocarbon recovery site. ‘Flowback’ fluid is a fluid from the well that was initially put into the well, such may be the case with recovered drilling fluids, completion fluids, fracturing fluids, injection fluids, and combinations thereof flowed back to the surface as recovered fluid. Production fluids are not put into the well prior to producing the well. The recovered water must be filtered and cleaned before the recovered water may be reintroduced into a subterranean reservoir wellbore, or discharged into the environment where the discharge of water/fluid will not be used.

‘Hydrocarbon’ is defined herein to include oil, gas, byproducts thereof, and combinations thereof. ‘Hydrocarbon recovery operation’ is defined herein as any operation typically used to recover hydrocarbons from a subterranean formation, such as but not limited to drilling operations, completion operations, injection operations, fracturing operations, production operations, and the like.

The recovered water is typically trucked from the site of the well to a filtration location to filter the recovered water, and then the filtered water is trucked from the filtration location to its next destination. The process of using trucks to transport the water to and from the well site of the hydrocarbon recovery operation increases the costs associated with hydrocarbon recovery because of the requisite man power needed to drive the trucks, as well as costs associated with fueling for the trucks. Although recovered fluid in this instance refers to water recovered from a hydrocarbon recovery operation, ‘recovered fluid’ also refers to hydrocarbon fluids obtained from such operations, as well as fluids typically filtered in municipal filtration systems and/or private well systems. In another instance, the recovered fluid may include a hydrocarbon fluid, water-based fluid, emulsions thereof, and combinations thereof.

In lieu of trucking water to and from a well site, a company may construct a piping system to pump the water from a well site through the piping system to a filtration location and optionally pump the filtered water back to a desired location, but such a piping system is a considerable expense. As an alternative to transporting the recovered fluid by truck or constructing a piping system, and/or a filtration system may be set up at the well site to filter the recovered fluid. The filtration system may use filter pods as the filtering component for removing contaminants therefrom.

However, the filter pods typically weigh several thousand pounds. Heavy machinery is often required to place the filter pods into fluid communication with the filtration system, move the placement of the filter pods within the filtration system, and/or remove the filter pods from the filtration system. Of course, the use of heavy machinery also adds to the cost of setting up, running the filtration system, and taking down the filtration system.

Moreover, should a filter pod malfunction, the entire fluid filtration system must be shut down for removal and/or cleaning of the filter pod. The shut down may last from 30 minutes to several hours depending on the particular reason of malfunctioning and whether the filter pod must be removed from the filtration system. A shutdown for removing and/or cleaning a filter pod increases the cost of the fluid filtration for the overall cost of the hydrocarbon recovery operation, as well as decreases revenue for the company performing the fluid filtration.

In addition, a person must manually clean the filter pods. Once the filter within the filter pod has reached its maximum ability for filtering fluids, the filtration system must be shut down to clean the filter pod or replace the filter within the filter pod. A person must open the filter pod to replace the filter therein with a clean filter. Just to open the filter pod may take as long as 30 minutes to an hour or more because special tools are often required.

Fluids are typically classified according to their base fluid. In water-based fluids, a continuous phase includes water or brine as a majority component. Oil can be emulsified in the water-based continuous phase where the oil-based fluid becomes up the discontinuous phase. “Water-based fluid” is used herein to include fluids having an aqueous continuous phase where the aqueous continuous phase can be all water or brine, an oil-in-water emulsion, an oil-in-brine emulsion, and combinations thereof. Brine-based fluids, of course are water-based fluids, in which the aqueous component is brine. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof.

Oil-based fluids are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in-non-aqueous emulsion, a brine-in-oil emulsion, or a brine-in-non-aqueous emulsion. In oil-based fluids, a continuous phase includes oil or another non-aqueous fluid as the majority component. Water or brine may be emulsified in the oil; therefore, the water or brine becomes the discontinuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

Drilling fluids are used to drill subterranean reservoir wellbores; drilling fluids may be oil-based fluids, water-based fluids, and the like. Completion fluids are typically brines, but may be any non-damaging fluid having proper density and flow characteristics.

A fracturing fluid is used to hydraulically fracture a subterranean reservoir by applying hydraulic pressure to crack the formation. Once hydraulic fracturing begins, and the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons. Most commercially used fracturing fluids are aqueous based liquids that have either been gelled or foamed. When the fluids are gelled, typically a polymeric gelling agent, such as a solvatable polysaccharide, e.g. guar and derivatized guar polysaccharides, is used. The thickened or gelled fluid helps keep the proppants within the fluid. Gelling can be accomplished or improved by the use of crosslinking agents or cross-linkers that promote crosslinking of the polymers together, thereby increasing the viscosity of the fluid.

Injection operations are considered a secondary method of hydrocarbon recovery and may be necessary when the primary recovery operation has left behind a substantial quantity of hydrocarbons in the subterranean formation. For example, in injection operations, the energy for producing the remaining hydrocarbons from the subterranean formation may be supplied by the injection of fluids into the formation under pressure through one or more injection wells penetrating the formation, whereby the injection fluids drive the hydrocarbons to one or more producing wells penetrating the formation.

Suitable injection fluids include, among other things, water, steam, carbon dioxide, and natural gas. However, the sweep efficiency of injection operations may vary greatly depending on a number of factors, such as variability in the permeability of the formation. In particular, where the subterranean formation contains high permeability zones, the injection fluids may flow through the areas of least resistance, e.g., through the high permeability zones, thereby bypassing less permeable zones. While injection operations may provide the energy necessary to produce hydrocarbons from the high permeability zones, hydrocarbons contained within less permeable zones may not be driven to the one or more production wells penetrating the formation.

Chemical compatibility of the fluid circulated within with the reservoir formation is key. Solids and/or chemical additives, such as polymers and surfactants, are known in the art for being introduced into the fluids for various reasons. Water-thickening polymers may increase the viscosity of the fluid and thus retard the migration of the fluid into the formation, which may be desired in drilling fluids and also fracturing fluids. A fluid used for one purpose within a subterranean reservoir is not typically suitable for another purpose within a subterranean reservoir wellbore because of the fluid's solid content, pH, ionic composition, and the like.

It would be desirable if smaller, more efficient, more portable, and more cost-effective filter components could be devised to decrease the overall costs of the filtration of the fluid.

### SUMMARY

There is provided, in one form, a fluid filtration apparatus having a fluid filtration platform and at least one self-cleaning filter component in fluid communication with the fluid filtration platform. The fluid filtration platform may have at least two segments where each segment may have at least one inlet, at least one outlet, and at least one valve. A first segment may be configured to be attachable to a second segment.

There is further provided, in another form, a fluid filtration system having at least one first tank comprising a recovered fluid, a fluid filtration apparatus in fluid communication with the first tank, and a second tank in fluid communication with the apparatus. The second tank may include or hold the filtered fluid until the filtered fluid is ready to be disposed, recycled, or reused. The fluid filtration apparatus may include at least one self-cleaning filter component in fluid communication with a fluid filtration platform. The fluid filtration platform may include at least two segments where each segment has at least one inlet, at least one outlet, and at least one valve. A first segment may be configured to be in fluid communication with a second segment.

There is further provided, in another form, a fluid filtration system having at least one charge pump for pumping a fluid into a fluid filtration apparatus, a fluid filtration apparatus in fluid communication with the charge pump(s), and at least one salt water disposal pump in fluid communication with the apparatus for pumping a fluid into at least one salt water disposal well. The apparatus may have or include a fluid filtration platform having at least two segments where each segment includes at least one inlet, at least one outlet, and at least one valve. A first segment may be configured to be in fluid communication with a second segment.

The portability of the fluid filtration platform(s) and the self-cleaning filter component(s) to form the fluid filtration apparatus allows for easier transport and easier assembly of the apparatus for use within a fluid filtration system.

### BRIEF DESCRIPTION OF THE DRAWINGS

FIG. 1 is a diagram of a non-limiting orientation of a fluid filtration apparatus having a platform and at least one self-cleaning filter component;

FIG. 2 is a diagram of a non-limiting orientation of self-cleaning filter components oriented in a parallel or perpendicular configuration within the apparatus;

FIG. 3 is an illustration of a non-limiting embodiment of a fluid filtration system where a recovered fluid may be fed into the fluid filtration system;

FIG. 4 is an illustration of a non-limiting embodiment of a fluid filtration system where a recovered fluid may be fed into the fluid filtration system;

FIG. 5 is a diagram of a non-limiting embodiment of the method;

FIGS. 6, 7, and 8 are non-limiting depictions of a self-cleaning filter component that is usable within the apparatus;

FIG. 9 is a non-limiting depiction of an assembled apparatus that may be transported via a trailer; and

FIG. 10 is an illustration of an assembled apparatus on a trailer that has been placed in fluid communication with the fluid filtration system.

### DETAILED DESCRIPTION

It has been discovered that a fluid filtration platform (hereinafter referred to as ‘the platform’) and at least one self-cleaning filter component may be quickly assembled together to form a fluid filtration apparatus (herein after referred to as ‘the apparatus’). The apparatus may be quickly placed in fluid communication with a fluid filtration system. In a non-limiting embodiment, the platform may be placed in fluid communication with the fluid filtration system, and then the self-cleaning filter component may be placed in fluid communication with the platform. Alternatively, the platform may be placed in fluid communication with the self-cleaning filter component to form the portable fluid filtration apparatus, and the apparatus may then be placed in fluid communication with the fluid filtration system. Both embodiments are encompassed by the use of ‘apparatus’ when discussing the placement of the apparatus into the fluid filtration system.

In a non-limiting embodiment, the apparatus may be assembled together at a different site from the fluid filtration site, and the assembled apparatus may be easily transported to the filtration site. Alternatively, the platform and self-cleaning filter component may be transported to the filtration site as separate pieces and assembled together at the filtration site. ‘Fluid filtration site’ refers to any site where a fluid needs to be filtered, such as but not limited to a hydrocarbon recovery operation site where recovered fluids need to be filtered. ‘Recovered fluid’ is defined as any fluid that needs to be filtered, such as a fluid recovered from a hydrocarbon recovery operation, a fluid within a municipality filtration system (e.g. filtering water for a city government), a well fluid filtration system, and combinations thereof.

‘Easily transported’ or ‘easily transportable’ is defined as being able to transport the assembled apparatus or individual platform and individual self-cleaning filter component by land, sea, or air in one shipment to the site of fluid filtration. In yet another non-limiting embodiment, the platform and self-cleaning filter component may have dimensions and/or weight specifications such that the platform and self-cleaning filter component may be easily assembled and/or transported, i.e. no heavy machinery or cranes would be needed to lift the platform and/or self-cleaning filter component. One or more people may be capable of lifting the platform and/or self-cleaning filter component. In the alternative, a forklift may be used to place or maneuver apparatus into fluid communication with a fluid filtration system.

The platform and self-cleaning filter component, whether assembled together as an apparatus or as individual pieces, may be transported by an 18-wheeler, as well as by a passenger vehicle or towed by a passenger vehicle. Transporting the platform and/or apparatus by a passenger vehicle (as opposed to an 18-wheeler, train, airplane, or ship) substantially decreases the costs of transporting the platform and self-cleaning filter component to the filtration site. Non-limiting examples of a passenger vehicle include a truck, sports utility vehicle, minivan, 4-door passenger car, a van, etc. This is contrasted to an 18-wheeler truck.

The portable fluid filtration platform may include at least two segments where a first segment may be configured to be attachable to a second segment. In a non-limiting example, the platform may range in weight from about 50 lbs independently to about 600 lbs, from about 150 lbs independently to about 500 lbs in another non-limiting embodiment, or from about 300 lbs or less in another non-limiting embodiment. Each segment may be placed in fluid communication with at least one self-cleaning filter component. A segment of the platform simply means a section of the platform that may be configured to be in fluid communication with a self-cleaning filter component.

A first segment of the platform may be in fluid communication with a second segment in series, in parallel, and combinations thereof. The platform of the apparatus may have as many segments necessary for filtering a recovered fluid. In addition or in the alternative, the platform of the apparatus may have as many segments as possible, so long as the platform is still easily transportable. Each segment may have or include a material, such as but not limited to, plastic, polyvinylchloride (PVC), metal, steel, rubber, and combinations thereof.

The apparatus may be placed in fluid communication with an onshore oilfield water filtration system, an offshore water filtration system, and combinations thereof. The apparatus may be configured to be in fluid communication with a municipality water filtration system, a well water filtration system, and combinations thereof. ‘Fluid communication’ is defined herein to mean that the fluid may flow between the platform and the self-cleaning filter component of the apparatus, between the apparatus and the fluid filtration system, and the like. Common techniques of placing the apparatus in fluid communication with the fluid filtration system may occur by directly attaching the apparatus to the piping of the fluid filtration system, such as by bolting, snapping, magnetic attraction, or any mechanism known to those skilled in the art that would maintain the fluid communication between the fluid filtration system and the apparatus. The same or similar techniques may be used for placing the self-cleaning filter component in fluid communication with the platform.

Each self-cleaning filter component may filter a fluid at a rate ranging from about 1 barrel independently to about 65 barrels of recovered fluid per minute, alternatively from about 5 barrels independently to about 55 barrels of recovered fluid per minute, or from about 10 barrels independently to about 40 barrels of recovered fluid per minute in another non-limiting embodiment. A barrel is about 42 gallons of fluid.

The self-cleaning filter component(s) may be in fluid communication with the platform in a horizontal configuration, a vertical configuration, and combinations thereof. ‘Self-cleaning’ is defined herein to mean that the filter component has or includes a mechanism and/or switch that allows the filter component to begin cleaning the interior of the self-cleaning filter component without intervention by a user and/or without having to shut the fluid filtration system down to initiate the cleaning of the filter component.

The self-cleaning filter component may have a weight ranging from about 20 lbs independently to about 600 lbs, alternatively from about 55 lbs independently to about 550 lbs, from about 75 lbs independently to about 450 lbs in another non-limiting embodiment, or from 150 lbs independently to about 250 lbs. The self-cleaning filter component may have dimensions that would allow it to be transported by a passenger vehicle, towed by a passenger vehicle, and/or transported by an 18-wheeler vehicle in a non-limiting embodiment. A first dimension may range from about 30 inches independently to about 95 inches, alternatively from about 40 inches independently to about 85 inches, or from about 50 inches independently to about 70 inches in another non-limiting embodiment. A second dimension may range from about 3 inches independently to about 24 inches, alternatively from about 6 inches independently to about 20 inches, or from about 12 inches independently to about 18 inches in another non-limiting embodiment. As used herein with respect to a range, “independently” means that any threshold may be used together with another threshold to give a suitable alternative range, e.g. about 20 lbs independently to about 55 lbs is also considered a suitable alternative range.

The described dimensions and weight specifications of the self-cleaning filter component and platform allow for a quick set-up when placing the self-cleaning filter component in fluid communication with the platform, and when placing the platform in fluid communication with the fluid filtration system because no cranes or heavy machinery are necessary to move the self-cleaning filter component and/or the platform. The need for heavy machinery or cranes to assemble an apparatus and/or place the apparatus in fluid communication with the fluid filtration system may negate the desire for a larger self-cleaning component, even though the larger self-cleaning filter component may filter more fluid. Eliminating such heavy machinery also decreases the overall costs of running the fluid filtration system.

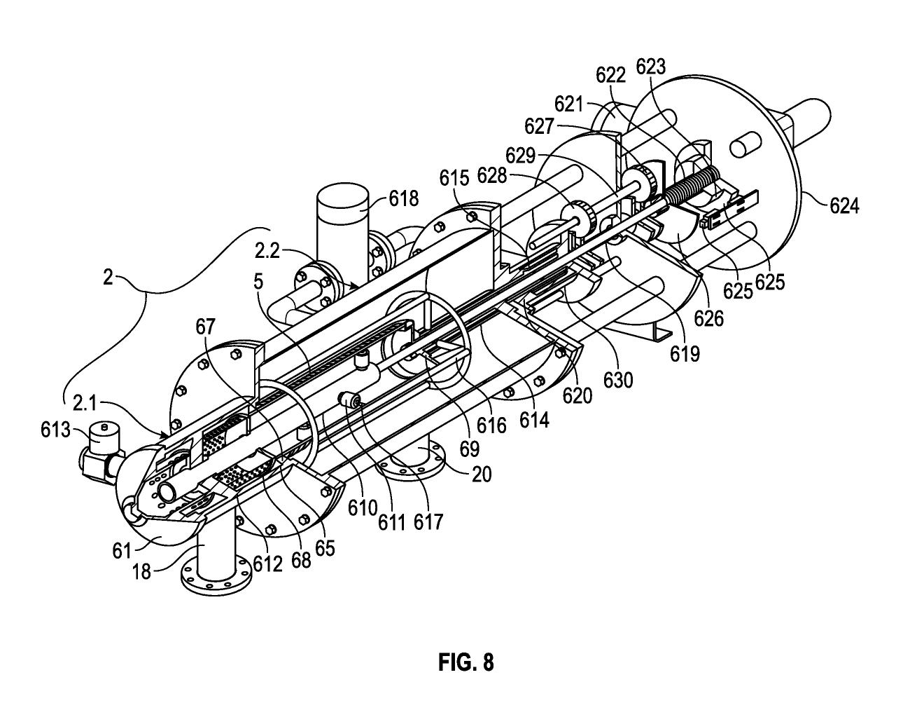

The self-cleaning filter component may have or include at least one self-cleaning mechanism, such as but not limited to a scraping device, a suction device, and combinations thereof. The self-cleaning mechanism may clean the interior of the self-cleaning filter component without having to halt the fluid filtration operation. In addition, the self-cleaning mechanism may be initiated by an internal mechanism or switch within or on the filter component, and no user intervention is needed to initiate the self-cleaning. For example, a non-limiting example of a self-cleaning mechanism is one that is initiated once the pressure within the filter component reaches a pre-determined threshold, and a signal may be sent to the self-cleaning mechanism to begin cleaning the interior of the filter component. In a non-limiting embodiment, the self-cleaning mechanism may be or include a scraping device, a brushing device, a suction device, and combinations thereof. A non-limiting embodiment of the self-cleaning mechanism is described in more detail in FIGS. 6-8, below.

In a non-limiting embodiment, a fluid filtration system may include a first tank comprising a recovered fluid, at least one apparatus in fluid communication with the first tank, and where the apparatus is also in fluid communication with a second tank. The recovered fluid may flow from the first tank, into the apparatus, and then into the second tank. There may be more than two tanks in any given fluid filtration system; ‘first’ and ‘second’ are used simply to denote the order of the tanks relative to how the fluid flows within the fluid filtration system, i.e. the fluid may be flowed from the first tank and in the direction of the second tank.

Although the recovered fluid may typically be a liquid, the term ‘fluid’ also encompasses a gaseous fluid. The filtering may occur at the site of a hydrocarbon recovery operation. The recovered fluid may be or include a production fluid, a spent fracturing fluid, an injection fluid, a spent drilling fluid, a spent completions fluid, a fluid recovered from a municipality and/or a well, and combinations thereof. A ‘spent’ fluid refers to a particular fluid that has already performed its function within a subterranean reservoir wellbore and has been flowed back to the surface of the wellbore.

In a non-limiting embodiment, a fluid may be filtered by flowing a recovered fluid through a portable fluid filtration apparatus having at least two segments, and filtering the recovered fluid to form a filtered fluid. In a non-limiting embodiment, the recovered fluid may be flowed through at least one settling tank. The optional settling tanks may be in fluid communication with the apparatus to flow the recovered fluid from the optional settling tank(s) into the apparatus. In yet another non-limiting embodiment, the filtered fluid may be discharged to the surrounding environment. Non-limiting examples of the ‘surrounding environment may be or include an SWD well, or any type of discharging to the environment allowed by the governmental authority known to those skilled in the art.

A settling tank may be used for separating solids from a recovered fluid. The contaminants, i.e. bacteria, solids, etc., may settle to the bottom, and the fluid may be flowed from the first settling tank into the apparatus. Alternatively, the fluid from a first settling tank may be flowed into a second settling tank for additional contaminant removal and/or separation of an oil-based fluid from a water-based fluid prior to flowing the fluid into the apparatus. Those skilled in the art of fluid filtration would understand the use and number of settling tanks needed within the fluid filtration system.

‘Filtered fluid’ is defined as a recovered fluid that has been filtered at least once; however, the filtered fluid may be refiltered as many times as necessary until the filtered fluid obtains pre-determined specifications of contaminants, such as amount of bacteria, solids content and/or solids size, amount of metals, and combinations thereof. The size of the solids within a filtered fluid may range from about 1 micron independently to about 100 microns in a non-limiting embodiment, or from about 10 microns independently to about 50 microns, alternatively from about 20 microns independently to about 40 microns.

Filtering the recovered fluid may include at least one process, such as but not limited to, removing solids from the recovered fluid, removing bacteria from the recovered fluid, removing at least one chemical from the recovered fluid, removing a petroleum-based fluid from the recovered fluid, removing a water-based fluid from the recovered fluid, and combinations thereof. ‘Removing’ is used herein to include separating, chemically altering, and/or physically removing the contaminant from the recovered fluid, such that the contaminant may no longer pose an issue within the fluid, once the contaminant has been removed. Contaminants, such as solids, bacteria, chemicals, and the like, and combinations thereof may be filtered from the recovered fluid in an amount ranging from about 50 wt % independently to about 99.9 wt %, alternatively from about 60 wt % independently to about 99 wt %, or from about 75 wt % independently to about 95 wt % in another non-limiting embodiment. A hydrocarbon or oil-based fluid may be considered a contaminant; a water-based fluid may be considered a contaminant; and combinations thereof depending on the desired type of fluid filtration to be performed on the recovered fluid.

Once filtered, the filtered fluid may be circulated into a subterranean reservoir wellbore during a hydrocarbon recovery operation, such as but not limited to a fracturing operation, an injection operation, a drilling operation, a completion operation, and combinations thereof. In a non-limiting embodiment, the filtered fluid may be a water-based fluid.

The fluid filtration system may filter a recovered fluid from a first hydrocarbon recovery operation, filter the recovered fluid at the hydrocarbon recovery operation site, and circulate the filtered fluid into a subterranean reservoir wellbore for a second hydrocarbon recovery operation as a continuous loop. In a non-limiting example, a fracturing fluid may be used in a fracturing operation, the fracturing fluid may be recovered from the wellbore; the recovered fluid is filtered by the fluid filtration system, and the filtered fluid may be reused during the same or different fracturing operation.

A method of assembling a fluid filtration system is also described where the method may include placing a portable fluid filtration platform in fluid communication with an oilfield fluid filtration system, and placing at least one self-cleaning filter component in fluid communication with the portable fluid filtration platform; the steps of assembling the fluid filtration system may occur in any order. Mechanisms of placing the platform in fluid communication with the fluid filtration system and/or placing the filter component in fluid communication with the platform may be or include inserting or attaching the portable fluid filtration platform into fluid communication with the fluid filtration system to allow for a quick set-up of the apparatus. Non-limiting examples of insertions or attachments that may allow for a quick set-up may be or include, but are not limited to, magnets, snaps, bolts, duct tape, or any mechanism that would allow the fluid to flow through the filtration platform and filter component in fluid communication, yet maintain the placement of the filtration platform in fluid communication with the filtration system when filtering a fluid therethrough.

Alternatively, the same set-up may allow for a quick removal of the platform and/or filter component in the event a filter component begins to malfunction or needs to be replaced. The filter component may be removed therefrom, and a new filter component may be placed in fluid communication with the platform and/or fluid filtration system in less than one hour.

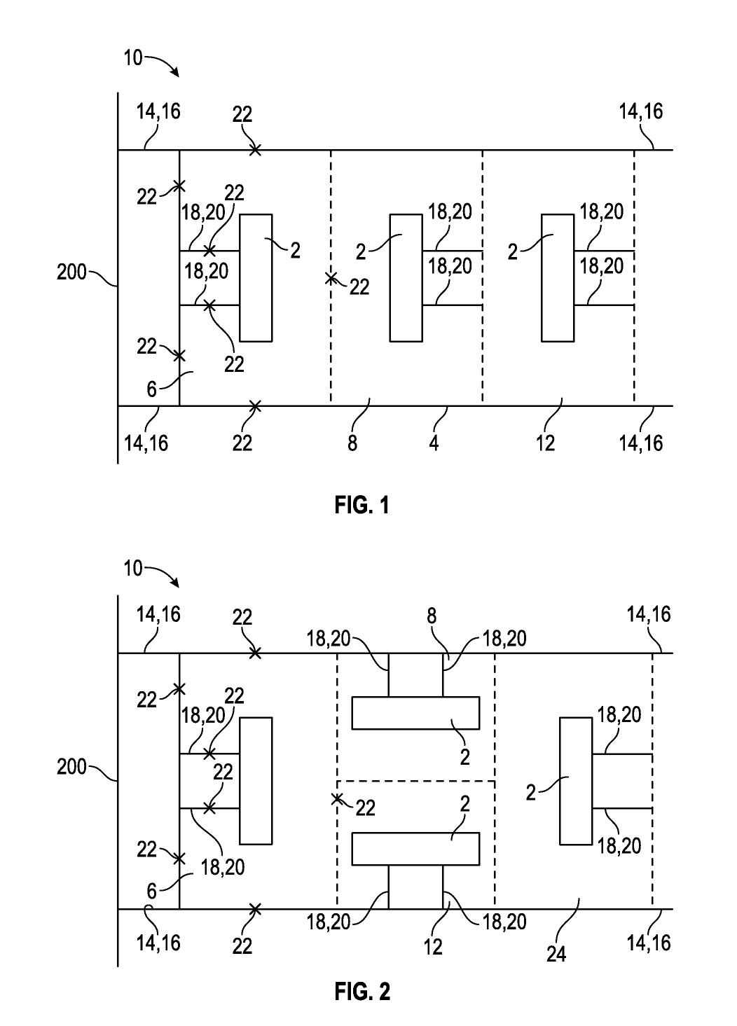

Now turning to the Figures, FIG. 1 is a diagram of a non-limiting orientation of a fluid filtration apparatus 10 having a platform 4 and at least one self-cleaning filter component 2. The platform 4 may have at least one platform inlet 14,16 and at least one platform outlet 14,16 for flowing a fluid into and out of the filter apparatus 10 and into and out of the fluid filtration system 200. The specific orientation of the inlet(s)/outlet(s) 14,16 may depend on the necessities of either the filter component(s) 2, the specifications of the fluid filtration platform 4 where the platform 4, the fluid filtration system 200, and combinations thereof. The apparatus 10 may have at least one segment where FIG. 1 depicts three segments noted as a first segment 6, a second segment 8, and a third segment 12. A dashed line separates each segment. The dashed line represents an optional pipe within the platform 4, although some of the piping represented by dashed lines would be required for the platform 4 depicted in FIG. 1 depending on the configuration of the platform 4. The segments 6, 8, and 12 are relatively similar to each other in terms of material, dimensions, etc. for ease of assembly and/or transportation of the platform 4. The platform 4 and/or the self-cleaning filter component 2 may have a filter inlet 18 and a filter outlet 20 for the fluid to flow in and out of the self-cleaning filter component 2.

Each segment may have at least one valve 22. Non-limiting placements of the valves 22 are depicted with regards to the first segment 6; however, similar placements of valves may be used for any segment within an apparatus 10. Moreover, more or less valves 22 may be used for the apparatus 10; one skilled in the art would understand the appropriate number and/or placement of the valves relative to the apparatus 10. Each valve 22 may be used to direct the flow of fluid through the apparatus 10 for filtering fluid. Closing a valve 22 would close a pathway through the apparatus 10 and allow a fluid to bypass the closed pathway. Opening a valve 22 would open a pathway through the apparatus 10 and allow a fluid to flow through the opened pathway.

In a non-limiting embodiment, at least one valve 22 may be disposed in a location relative to the self-cleaning filter 2 component to increase the pressure within the self-cleaning filter component 2 when flowing a fluid therethrough in a non-limiting embodiment. For example, a valve 22 may be placed on at least one filter inlet 18 to increase the pressure of the fluid flow into the self-cleaning filter component 2.

The valves may be strategically opened or closed to allow the filter components 2 to filter a fluid in parallel, in series, or a combination thereof within a platform 4. ‘In parallel’ is defined herein as flowing a fluid through two or filter components or two or more segments at about the same time, regardless of the flow rate into each filter component. ‘In series’ is defined herein as flowing a fluid through each self-cleaning filter component or each segment one at a time in a consecutive manner.

A first segment may be in fluid communication with a second segment in parallel, in series, and combinations thereof. In addition, a first self-cleaning filter component may be in fluid communication with at least a second self-cleaning filter component in parallel, in series, and combinations thereof within the same segment or platform. A non-limiting benefit of having self-cleaning filter components or segments in parallel within a platform is that a self-cleaning first self-cleaning filter component may be a back-up to a second self-cleaning filter component. If the first or second self-cleaning filter component malfunctions and needs to be repaired or replaced, or when the self-cleaning filter component begins the self-cleaning process, the pathways routing fluid to the malfunctioned self-cleaning filter component may be closed, and the fluid may be routed to a functioning self-cleaning filter component. Thus, the parallel filter components may continue filtering a fluid, while the repair, removal, or self-cleaning occurs.

A non-limiting benefit of having self-cleaning filter components or segments in series is that each self-cleaning filter component may perform a different function. For example, a first self-cleaning filter component may filter solids at 100 microns, a second self-cleaning filter component may filter solids at 50 microns, and a third self-cleaning filter component may filter bacteria and/or chemicals from the fluid. ‘First’, ‘second’, and ‘third’ are not meant to limit the number of self-cleaning filter components per segment or platform; such notations are only used to denote a chronological order of fluid flow through the self-cleaning filter components as a series configuration. In addition, the strategic placement of valves on the filter component and/or platform may allow the configuration of the segments/filter components to be switched from in parallel to in series, and vice versa.

The filter component(s) may be in fluid communication with the platform 4 in a horizontal configuration; however, the self-cleaning filter components may be in fluid communication with the platform in a vertical configuration. One skilled in the art would understand how to configure the platform inlet and/or platform outlet to configure with the self-cleaning filter component inlet and self-cleaning filter component outlet, if necessary.

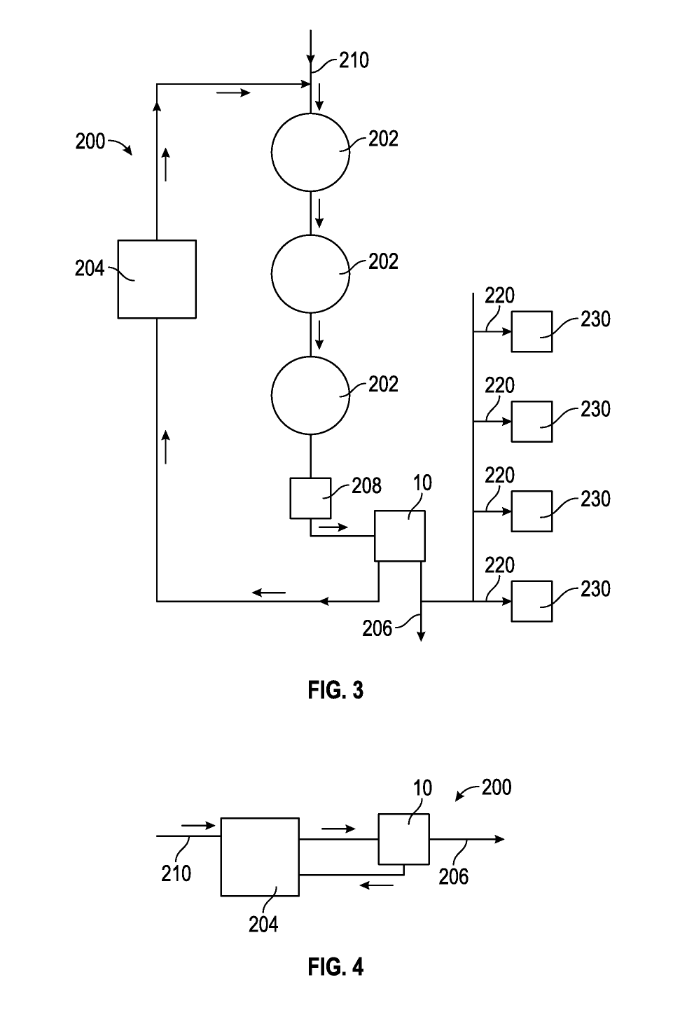

In yet another non-limiting embodiment, the segments 6, 8, 12, and 24 may be oriented in a parallel or perpendicular configuration within the apparatus 10 as depicted in FIG. 2.

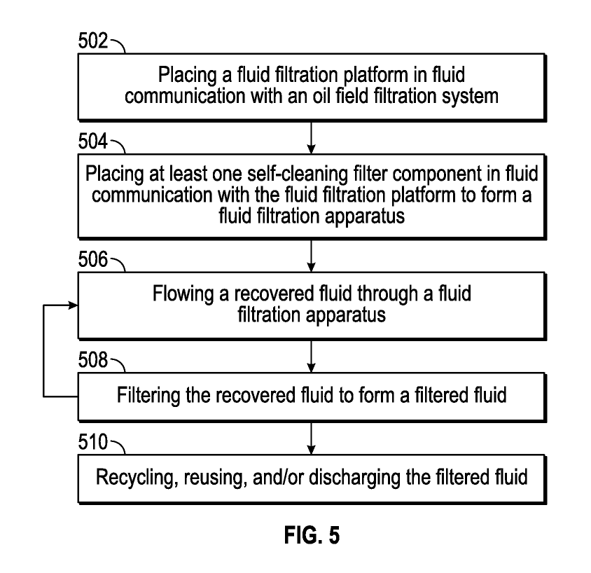

FIG. 3 is an illustration of a non-limiting embodiment of a fluid filtration system 200 where a recovered fluid 210 is fed into the system 200. The fluid may be fed into an optional settling tank 202; FIG. 3 depicts three settling tanks, but as many settling tanks may be used as reasonably necessary for the type of fluid being filtered. In addition, the settling tanks 202 are depicted in FIG. 3 as being in series, but the settling tanks 202 may be in parallel, or a combination of in series and in parallel. The solids and/or fluid from the settling tank 202 may be separated and flowed into a pump 208. In a non-limiting embodiment, the pump 208 may be a charge pump, which may add additional force to the fluid to push the fluid from the settling tanks 202 into the apparatus 10.

The fluid may be flowed from the pump 208 and into the apparatus 10 to further filter the fluid where the self-cleaning filter component filters the fluid according to the set-up of the filter component, as well as the types of filters within the filter component. Non-limiting suppliers of filter components suitable for the filtration system 200 may be or include AMIAD™, FORSTA™, EATON™, TEKLEEN™, and combinations thereof. Non-limiting embodiments of the self-cleaning filter components supplied by AMIAD™ may be or include, but are not limited to, the M100 series, the SAF series (e.g. the SAF 3000, SAF 4500, and/or the SAF 6000), the Omega 1 series, the Omega 2 series, and the like. Non-limiting embodiments of the self-cleaning filter components supplied by FORSTA™ may be or include, but are not limited to, the 180 series, the 180-FRP series, the 180C series, the 90 series, the low pressure series (i.e. to filter fluids where the 35 psi system is not available), and combinations thereof. Non-limiting embodiments of the self-cleaning filter components supplied by EATON™ may be or include, but are not limited to, the AFR series (a filter component configured to be upright instead of horizontal), the MCF series, the DCF series, the F-Series, and combinations thereof. Non-limiting embodiments of the self-cleaning filter components supplied by TEKLEEN™ may be or include, but are not limited to, the ABW series, the LPF series, the OBF series, the CSB series, and the like.

In a non-limiting embodiment, the filtered fluid may be flowed from the apparatus 10 through a disposal pump 220 (also known as an H-pump) and into a salt-water disposal (SWD) well 230. A disposal pump 220 functions similarly to a charge pump 208 by increasing the pressure to the filtered fluid to push the filtered fluid into the SWD well 230. FIG. 3 depicts four SWD wells, but there may be as few as only one SWD well, or as many as have been permitted by the proper government authority. Each SWD well 230 may be in fluid communication with one or more disposal pumps 220; alternatively, one disposal pump 220 may supply several SWD wells 230 with filtered fluid, such as filtered water-based fluids in a non-limiting embodiment. A SWD well is a disposal site for water collected as a byproduct from a hydrocarbon recovery operation. SWD wells may be used to dispose of water related to onshore hydrocarbon operations, offshore hydrocarbon operations, and the like.

In a non-limiting embodiment, at least one injector pump (not shown) may be placed in front of and/or after the apparatus 10 for adding chemicals to the recovered fluid and/or filtered fluid. Such chemicals may aid in separating or decreasing the amount of bacteria in the fluid, adjusting the pH of the fluid, preventing corrosion by the fluid to metal surfaces, and combinations thereof. In addition or in the alternative, a submicron filter (not shown) may be placed in front of and/or after the apparatus 10 for additional filtration to the recovered fluid and/or filtered fluid to decrease the amount of bacteria present in the fluid, separate additional solids, and combinations thereof.

The filtered fluid may be flowed from the apparatus 10 to a holding tank 204, which holds the fluid until the filtered fluid is to be recycled, reused, and/or discharged. The filtered fluid may be flowed from the holding tank 204 back into the optional first settling tank 202 to repeat a closed-loop cycle of filtering the fluid.

Alternatively, the filtered fluid may be flowed from the apparatus 10 as effluent fluid 206 to be reused in another hydrocarbon recovery operation (whether it is the same operation or a different operation), trucked to a second location different from the first location (e.g. the location of a hydrocarbon recovery operation), or a combination thereof. In another non-limiting embodiment, the apparatus 10 may filter the recovered fluid from a hydrocarbon recovery operation, and the filtered fluid may supply a continuous use to the same or different hydrocarbon recovery operation in a closed-loop manner. ‘Closed-loop’ as used herein refers to circulating the fluid into a subterranean reservoir wellbore, recovering the fluid, and filtering of the fluid in a repeatable cycle.

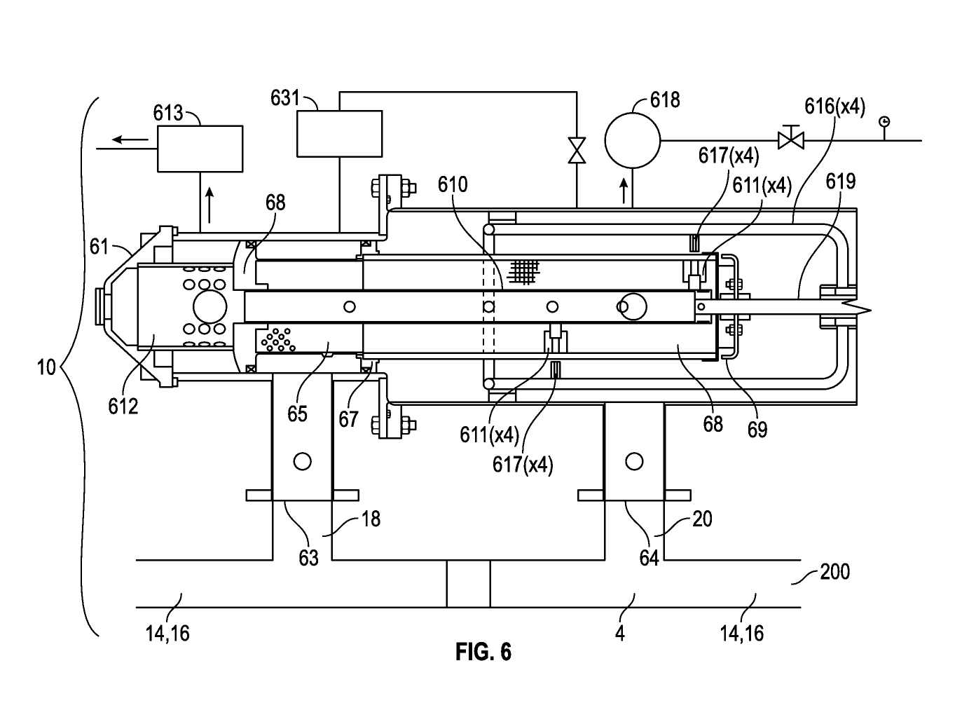

FIG. 4 is an illustration of a non-limiting embodiment of a fluid filtration system 200 where a recovered fluid 210 is fed into the system 200. The recovered fluid 210 may be flowed into a holding tank 204, which holds the fluid until the recovered fluid should be filtered. For example, the holding tank 204 may hold the recovered fluid until enough recovered fluid has been obtained to create enough pressure within the filtration system to properly flow the recovered fluid therethrough to create a filtered fluid.

The fluid may be flowed from the holding tank 204 into the apparatus 10, which filters the fluid according to the set-up of the self-cleaning filter components, as well as the types of filter elements within the self-cleaning filter components. Examples of non-limiting self-cleaning filter components usable within the system 200 are mentioned in FIG. 3. The filtered fluid may be flowed from the apparatus 10 back to the holding tank 204. The filtered fluid may then be flowed back into the filtration apparatus 10 for at least a second filtration, i.e. a refiltering of the filtered fluid.

Alternatively, the filtered fluid may be flowed from the apparatus 10 as effluent fluid 206 to be reused in another hydrocarbon recovery operation (whether it is the same operation or a different operation), trucked to a second location different from the first location (e.g. the location of a hydrocarbon recovery operation), discharged into the environment, or a combination thereof.

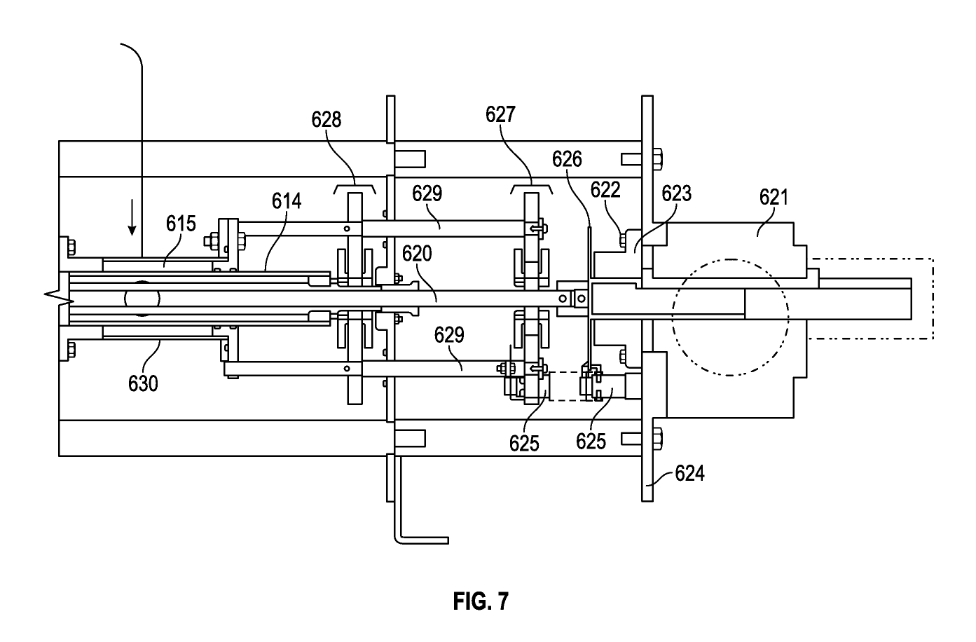

FIG. 5 is a diagram of a non-limiting embodiment of the method. The method may include the optional step 502 of placing a fluid filtration platform in fluid communication with an oilfield filtration system; the optional step 504 of placing at least one self-cleaning filter component in fluid communication with the fluid filtration platform to form a fluid filtration apparatus; the step 506 of flowing a recovered fluid through a fluid filtration apparatus; the step 508 of filtering the recovered fluid to form a filtered fluid; and the optional step 510 of recycling, reusing, and/or discharging the filtered fluid.

FIGS. 6, 7, and 8 show the overall structure of a self-cleaning filter component from AMIAD™ that is usable within the apparatus 10 placed within a fluid filtration system 200, described above. A non-limiting example of a self-cleaning filter component 2 is also described in U.S. Pat. No. 7,055,699, which is herein incorporated by reference in its entirety.

A self-cleaning filter component 2 may be composed of two parts for convenience of assembly: a small diameter housing section 2.1 and a large diameter housing section 2.2. The small diameter housing section 2.1 includes a housing lid 61 that is detachable for maintenance operation, and an inlet pipe 18 for introducing a fluid into the filter component 2 to be filtered. The large diameter housing section 2.2 may have an outlet pipe 20 for discharging filtrate filtered from the fluid.

A cylindrical coarse filter element 65 (which may be a perforated cylinder member in a non-limiting embodiment) may be placed concentrically within the small diameter housing section 2.1 and between two hydraulically sealing partitions. The partition on the right side in FIG. 6 (the side of the large diameter housing section 2.2) may be the fine filter element partition 67 positioned between the fluid to be filtered and the filtrate of the fine filter element 66. The other partition on the left side (the side of the housing lid 61) may be an exhaust chamber partition 68 positioned between the recovered fluid and the material to be filtered therefrom. The cylindrical coarse filter element 65 may be designed to protect the self-cleaning filter component from large solid particles by filtering large particles on its outer surface. The coarse filter element 65 may be coupled to the cylindrical fine filter element 66, which may be placed in the large diameter housing section 2.2.

The fine filter element 66 may be composed of a stainless steel mesh member having an aperture size ranging from about 1 micron independently to about 1000 microns, which means that such a filter element may filter particles ranging in size from about 1 micron independently to about 1000 microns. Alternatively, the fine filter element 66 may have an aperture size ranging from about 10 microns independently to about 100 microns. The fine filter element 66 may be supported and capped by a hydraulically sealing centering flange 69. In a non-limiting embodiment, the filtrate of the coarse filter element 65 serves as the raw water to be treated on the inner surface of the fine filter element 66. Accordingly, the region from the outer side of the coarse filter element 65 (defined by the exhaust chamber partition 68) to the inner side of the fine filter element 66 may be referred to as the raw water chamber.

Recovered fluid may be introduced into the filter component 2 via an inlet pipe 18. In a non-limiting embodiment, the inlet pipe 18 may be flanged. Alternatively, the inlet pipe 18 may be disposed on the platform 4 instead of the inlet pipe 18 being disposed on the filter component 2. The fluid may be passed through the cylindrical coarse filter element 65 from the outer side to the inner side for a preliminary filtering. Subsequently, the filtered fluid may be passed through the cylindrical fine filter element 66 from the inner side to the outer side for secondary filtering, and finally discharged from the outlet pipe 20 as filtered fluid.

Similar to the inlet pipe 18, the outlet pipe 20 may be flanged. Alternatively, the outlet pipe 20 may be disposed on the platform 4 in addition to or in the alternative from the outlet pipe 20 being disposed on the filter element 24. In the filtering process, the suspended material accumulates on the inner surface of the fine filter element 66.

A non-limiting part of the self-cleaning mechanism may include a hollow suction scanner shaft 610 provided along the centerline of the cylindrical filter housing 2. A plurality of suction nozzles 611 that extend to approximately ⅛″ from the inner surface of the fine filter element 66 may be disposed on the shaft 610. The shaft 610 may be sealed on one end (on the side of the sealing flange 69), while the other end is open to the exhaust chamber 612. The exhaust chamber 612 may be connected to an automatic exhaust valve 613 to be opened to the atmosphere. Thus, when the automatic exhaust valve 613 is opened, the differential pressure between the supply pressure and the atmospheric pressure generated at the outlet of the exhaust chamber 612 may create a vacuum effect at the inlet of each nozzle 611. As a result, contaminants may be drawn away from the fine filter element surface, through the suction scanner shaft 610, and out of the automatic exhaust valve 613.

Another non-limiting part of the self-cleaning mechanism may include a hollow backwash spindle 614. The backwash spindle 614 may be composed of a hollow center shaft, and may have inlets on one end opened to a backwash chamber 615 for introducing filtrate. On the other end, the backwash spindle 614 may include at least one pipe 616 (two are shown) disposed in a cross-shape arrangement, each pipe bearing a backwash nozzle 617. Each backwash nozzle 617 may extend to approximately ½″ from the external surface of the fine filter element 66, and may face a corresponding suction nozzle 611 located on the inside of the fine filter element 66. The pipe(s) 616 may be of a high-pressure type having a size of W. The pipe(s) 616 may be connected to one another at the far end (on the left in FIG. 8) so as to equalize the discharge pressure as evenly as possible. A booster pump 618 with a pressure regulator may be connected between the backwash chamber 615 and the large diameter housing section 2.2. With this arrangement, a portion of the filtrate may be pressurized and fed into the backwash chamber 615. From the backwash chamber 615, the filtrate may be pushed through the inlet of the hollow backwash spindle 614, advanced along the ½′ pipe(s) 616, and then jetted out through the backwash nozzles 617.

The centering flange 69 may be firmly supported by a fixed hollow support rod 619. Disposed through the support rod 619 may be a shaft 620 connecting between the suction scanner shaft 610 and a drive shaft 622. The connecting shaft 620 may serve as a propelling axle that transmits a screw-like or rotary motion from the drive shaft 622 to the suction scanner shaft 610. The drive shaft 622, which may be connected to the right end of the connecting shaft 620, is a revolving screw (worm) driven by a geared electric motor 621. Via a drive bushing 623 provided on the motor base, the drive shaft 622 may be rotated and axially moved forward or backward according to the revolving direction of the geared electric motor 621. This movement may move the suction nozzles 611 over the entire inner surface of the fine filter element 66. At least one two limit switch 625 and/or a limit switch plate 626 may limit the excursion of the drive shaft 622, which may be appropriately disposed along the drive shaft housing 624.

In order to drive the hollow backwash spindle 614, the connecting shaft 620 may have a first gear assembly unit 627. The first gear assembly unit 627 may include a center wheel mounted on the connecting shaft 620 and two cogwheels. These three wheels may have the same diameters, may be toothed similarly, and may mesh together in line. Each cogwheel has a shaft 629, which may extend in parallel with the connecting shaft 620, through a second gear assembly unit 628, and the flange of the backwash chamber housing 630. The second gear assembly unit 628 may have two cogwheels for the respective two shafts 629. These two cogwheels may mesh with a center wheel attached to the end of the hollow backwash spindle 614. All of the above-noted wheels may have a similar diameter and may be similarly toothed, so as to allow the suction scanner shaft 610 and the hollow backwash spindle 614 to rotate and move synchronously in the same cycle. The bearings of the wheels in each gear assembly unit may be composed of a highly durable plastic material to cope with mechanical stress that may occur in transmitting axial motion from the drive shaft 622 to the hollow backwash spindle 614.

During operation of the self-cleaning mechanical filter, a non-limiting cleaning cycle may be performed as follows: an exhaust valve may be opened to atmosphere. A few seconds later, the booster pump 618 may be started. In addition, the geared electric motor unit 621 may begin rotating the suction scanner shaft 610, as well as the hollow back wash spindle 614. During each cleaning cycle, the motor unit 621 may rotate the suction scanner shaft 610 and the spindle 614, such that the suction nozzles 611 and the backwash nozzles 617 are moved over the entire filter element 66 along its surfaces on both sides. As will be known, the self-cleaning cycle performed as an automatic process may be initiated by a pressure differential switch 631 to be activated at a point when contaminant material is accumulated on the fine filter element 66 (when the pressure differential across the fine filter element reaches a pre-set value), and/or by a timer to be activated at predetermined time intervals.

The degree of self-cleaning efficiency attained by the filter element described in FIGS. 6, 7, and 8 may be sufficiently high such that the filter element is particularly suitable for filtration of fluids containing a high load of organic materials, such as a hydrocarbon effluent, a chemical effluent, a bacterial effluent, and the like. In a non-limiting embodiment, the filter element may continuously operate for a period ranging from about 1 day independently to over 6 months without stopping the filtration system 200 to manually clean the fine filter element, alternatively from about 7 days independently to about 12 months.

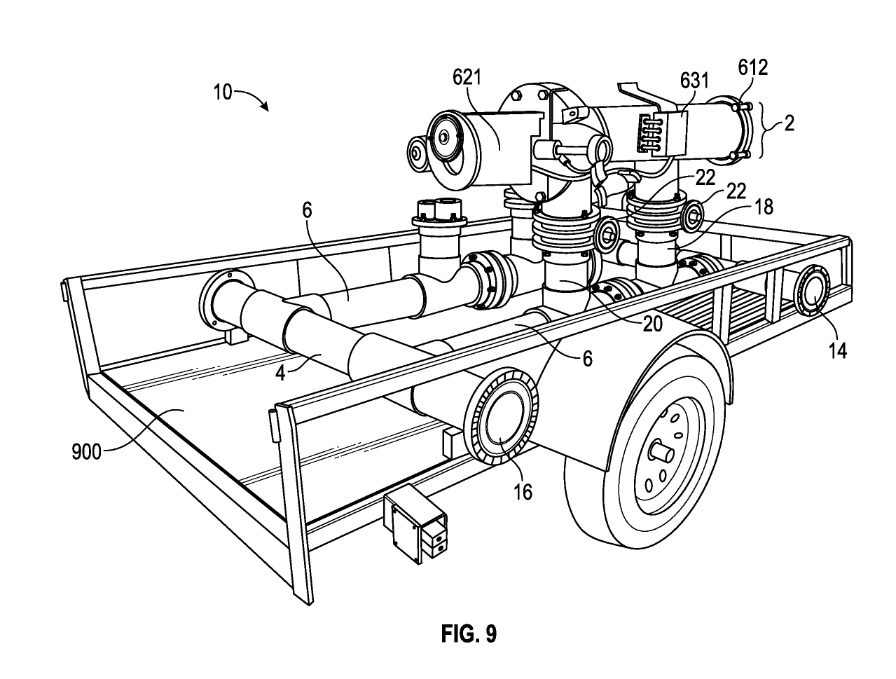

FIG. 9 is a depiction of an assembled apparatus 10 that may be transported via a trailer 900. The apparatus 10 may include the platform 4 and the filter component 2. Therefore, the trailer 900 may transport the apparatus 10 directly to the site of the fluid filtration system (not shown), placed into the fluid filtration system for filtering a recovered fluid, and removed from the filtration system without removing the apparatus 10 from the trailer 900. If the filter component 2 begins to malfunction, the filter component may be removed from the platform 4, and a different functioning filter component may be placed onto the platform 4 to continue the fluid filtration of the recovered fluid.

For this particular filter component 2, i.e. an AMIAD filter component, the motor 621 end of the filter component 2 may be the ‘back’ end of the filter component. The filter component 2 and platform 4 may be placed on the trailer 900 in either orientation; however, the platform input 14 will be on the same side of the apparatus 10 as the exhaust chamber 612.

In an alternative embodiment, the apparatus 10 may be mounted onto a platform (not shown) for placing the apparatus into fluid communication with the fluid filtration system apart from the trailer 900. A non-limiting example of a platform is a ‘skid’, which is a frame on which portable equipment may be mounted to facilitate handling of the equipment with cranes, trailers, flatbed trucks, forklifts, and the like. The skid may be robust, and may be designed with attachment points for hooks, chains, or cables. The skid may have at least two lengthwise beams to facilitate sliding the equipment into place at the site of fluid filtration and/or the hydrocarbon recovery operation.

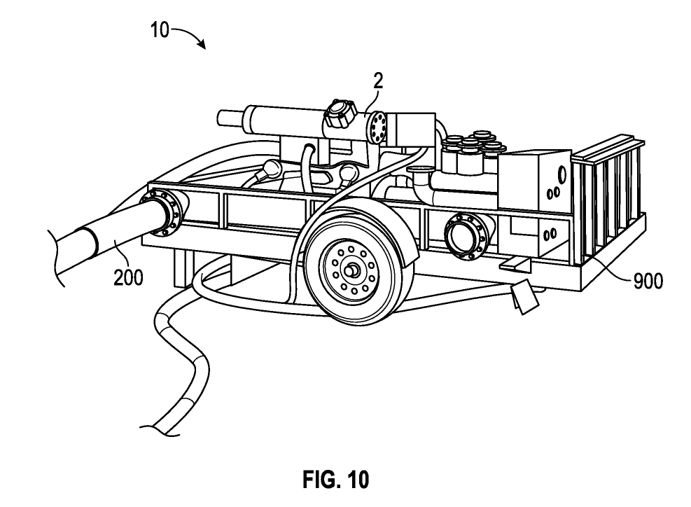

FIG. 10 is an illustration of an assembled apparatus 10 on a trailer 900 that has been placed in fluid communication with the fluid filtration system 200.

It will be evident to those skilled in the art that the present invention is not limited to the details of the foregoing illustrative embodiment. For example, changes may be made in the drive mechanism for the suction nozzles and the backwash nozzles. Further, only one each of suction nozzle and backwash nozzle may be provided, or, alternatively, more than 5 of those nozzles may be provided. In addition, the filter element 66 may be any filter insertable into the self-cleaning filter component for filtering a hydrocarbon contaminant, a chemical contaminant, a solid, a bacterial contaminant, and the like. The present embodiment is to be considered in all respects as illustrative and not restrictive. The scope of the present invention is solely defined by the appended claims.

In the foregoing specification, the invention has been described with reference to specific embodiments thereof, and has been described as effective in providing fluid filtration apparatuses, fluid filtration systems, and methods of using the same. However, it will be evident that various modifications and changes can be made thereto without departing from the broader spirit or scope of the invention as set forth in the appended claims. Accordingly, the specification is to be regarded in an illustrative rather than a restrictive sense. For example, specific platforms, self-cleaning filter components, recovered fluids, uses of the filtered fluids, and the like falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the fluid filtration apparatus may consist of or consist essentially of a fluid filtration platform and at least one self-cleaning filter component in fluid communication with the fluid filtration platform. The fluid filtration platform may have at least two segments where each segment may have at least one inlet, at least one outlet, and at least one valve. A first segment may be configured to be attachable to a second segment.

A fluid filtration system may consist of or consist essentially of at least one first tank comprising a recovered fluid, a fluid filtration apparatus in fluid communication with the first tank, and a second tank in fluid communication with the apparatus.

A fluid filtration system may consist of or consist essentially of at least one charge pump for pumping a fluid into a fluid filtration apparatus, a fluid filtration apparatus in fluid communication with the charge pump(s), and at least one salt water disposal pump in fluid communication with the apparatus for pumping a fluid into salt water disposal wells.

The words “comprising” and “comprises” as used throughout the claims, are to be interpreted to mean “including but not limited to” and “includes but not limited to”, respectively. The words “comprising” and “comprises” as used throughout the claims, are to be interpreted to mean “including but not limited to” and “includes but not limited to”, respectively.

What is claimed is:

1. A fluid filtration apparatus comprising:
a fluid filtration platform comprising at least two segments; wherein each segment comprises at least one inlet, at least one outlet, and at least one valve; and wherein a first segment is configured to be attachable to a second segment; and
at least one self-cleaning filter component in fluid communication with the fluid filtration platform.

2. The fluid filtration apparatus of claim 1, wherein the first segment is attachable to the second segment in series, in parallel, and combinations thereof.

3. The fluid filtration apparatus of claim 1, wherein the platform is configured to be in fluid communication within an onshore oilfield water filtration system, an offshore oilfield water filtration system, and combinations thereof.

4. The fluid filtration apparatus of claim 1, wherein the platform is configured to be in fluid communication with a municipality water filtration system, a well water filtration system, and combinations thereof.

5. The fluid filtration apparatus of claim 1, wherein the apparatus is easily transportable.

6. The fluid filtration apparatus of claim 1, wherein each segment comprises a material selected from the group consisting of plastic, polyvinylchloride (PVC), metal, steel, rubber, and combinations thereof.

7. The fluid filtration apparatus of claim 1, wherein the at least one self-cleaning filter component comprises at least one self-cleaning mechanism selected from the group consisting of a scraping device, a brushing device, a suction device, a backwashing device, and combinations thereof.

8. The fluid filtration apparatus of claim 1, wherein the at least one valve is disposed in a location relative to the at least one self-cleaning filter component to increase the pressure within the at least one self-cleaning filter component when flowing a fluid therethrough.

9. The fluid filtration apparatus of claim 1, wherein the apparatus weighs less than about 1500 pounds.

10. The fluid filtration apparatus of claim 1, wherein the at least one self-cleaning filter component is in fluid communication with the platform in a configuration selected from the group consisting of a horizontal configuration, a vertical configuration, and combinations thereof.

11. A fluid filtration system comprising:
at least one first tank comprising a recovered fluid;
a fluid filtration apparatus in fluid communication with the at least one first tank; wherein the apparatus comprises:
a fluid filtration platform comprising at least two segments; wherein each segment comprises at least one inlet, at least one outlet, and at least one valve; and wherein a first segment is configured to be in fluid communication with a second segment; and
at least one self-cleaning filter component in fluid communication with the fluid filtration platform; and
at least one second tank in fluid communication with the apparatus;
wherein the at least one second tank comprises a filtered fluid.

12. The fluid filtration system of claim 11, wherein the recovered fluid is selected from the group consisting of a production fluid, a spent fracturing fluid, a spent injection fluid, a spent drilling fluid, a spent completions fluid, and combinations thereof.

13. The fluid filtration system of claim 11, wherein the fluid filtration system is selected from the group consisting of an onshore oilfield water filtration system, an offshore oilfield water filtration system, a municipality water filtration system, a well water filtration system, and combinations thereof.

14. The fluid filtration apparatus of claim 11, wherein the first segment is attachable to the second segment in series, in parallel, and combinations thereof.

15. The fluid filtration apparatus of claim 11, wherein the at least one self-cleaning filter component comprises at least one self-cleaning mechanism selected from the group consisting of a scraping device, a brushing device, a suction device, a backwashing device, and combinations thereof.

16. A fluid filtration system comprising:
at least one charge pump for pumping a fluid into a fluid filtration apparatus;
a fluid filtration apparatus in fluid communication with the at least one charge pump; wherein the apparatus comprises:
a fluid filtration platform comprising at least two segments; wherein each segment comprises at least one inlet, at least one outlet, and at least one valve; and wherein a first segment is configured to be in fluid communication with a second segment; and
at least one self-cleaning filter component in fluid communication with the fluid filtration platform; and
at least one salt water disposal pump in fluid communication with the apparatus for pumping a fluid into at least one salt water disposal well.

17. The fluid filtration system of claim 16, wherein the recovered fluid is selected from the group consisting of a production fluid, a spent fracturing fluid, a spent injection fluid, a spent drilling fluid, a spent completions fluid, and combinations thereof.

18. The fluid filtration system of claim 16, wherein the fluid filtration system is selected from the group consisting of an onshore oilfield water filtration system, an offshore oilfield water filtration system, a municipality water filtration system, a well water filtration system, and combinations thereof.

19. The fluid filtration apparatus of claim 16, wherein the first segment is attachable to the second segment in series, in parallel, and combinations thereof.

20. The fluid filtration apparatus of claim 16, wherein the at least one self-cleaning filter component comprises at least one self-cleaning mechanism selected from the group consisting of a scraping device, a brushing device, a suction device, a backwashing device, and combinations thereof.
